(19) United States
(12) Patent Application Publication
(10) Pub. No.: US 2009/0006182 A1
(43) Pub. Date: Jan. 1, 2009

(54) Forecasting Volume for a Promotion

(76) Inventor: Mark Andrew Gammon, Boise, ID (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/947,233

(22) Filed: Nov. 29, 2007

Related U.S. Application Data
(60) Provisional application No. 60/937,886, filed on Jun. 29, 2007.

(51) Int. Cl. G06Q 30/00

(52) U.S. Cl. 705/10; 705/14

(57) ABSTRACT

Forecasting the volume of a product as part of a promotion provides for better resource allocation by the retailer and manufacturer to support the promotion.

### CROSS REFERENCE TO RELATED APPLICATION

This application claims the benefit of U.S. Provisional Application No. 60/937,886, filed Jun. 29, 2007

### FIELD OF INVENTION

The present invention is directed to a method of forecasting the volume impact of a target promotion.

### BACKGROUND OF THE INVENTION

There is a continuing need for a reliable means for forecasting the product volume to be sold during a promotion in a retail store. Such forecasting will allow for better promotion design, resource allocation (e.g., return on investment), inventory planning, and product portfolio management, among other benefits.

See e.g., US 2003/0130883 A1; US 2005/0273380 A1; US 2005/0278218 A1; and US 2002/0169665 A1, and US 2003/0050828 A1; as well as U.S. Pat. Nos: 6,029,139; 6,151,582; 6,954,736; 7,039,606; 7,054,837; 7,072,843; 7,120,596; 7,155,402; and 7,171,379.

### SUMMARY OF THE INVENTION

The present invention attempts to address these and other needs by providing, in a first aspect of the invention, a method for forecasting target volume of a product for a target promotion in a store comprising the steps: (a) assessing purchase data; (b) identifying the single highest selling historical promotion from the purchase data; and (c) forecasting the target volume of the product of the target promotion product based upon the highest selling historical promotion identified.

### DETAILED DESCRIPTION OF THE INVENTION

### Definitions:

“Product” is broadly defined as encompassing any product, service, communication, entertainment, environment, organization, system, tool, and the like, sold in a store. A product may be perishable or non-perishable, consumable or durable. Many products are coded (i.e., product codes) such as the use of UPC (universal product code) or SKU (stock keeping unit) of the product. Products can also be characterized by brand name, size, and flavor (e.g., fragrance or taste variety). Exemplary product forms and brands are described on The Procter & Gamble Company's website, www.pg.com, and the linked sites found thereon.

“Purchase data” is data that is a result, at least in part, of shoppers purchasing a product at a store. Purchase data may be household-based or transaction-based or a combination thereof. Examples of ways of obtaining purchase data may include those methods described in: U.S. Pat. No. 5,490,060 (entitled “Passive Data Collection System for Market Research Data”); or International Patent Publication WO 95/30201 (entitled “Method and Apparatus for Real-Time Tracking of Retail Sales of Selected Products”). Purchase data may come from point-of-sale terminals, or store processors, or communication networks, or combinations thereof. Purchase data may be obtained from a data supplier (such as ACNielsen or Information Resources, Inc.) or directly from a store or retailer.

Purchase data may comprise data about one or more historical promotions. Such data may include the number or volume of promotional products sold during the promotional time period. Purchase data can formatted, entered into, and assessed through programs known in the art such as ACCESS (MIRCOSOFT) or EXCEL (MICROSOFT) and by other methods known in the art.

“Promotion” is a special merchandizing event which seeks to draw the shopper's attention to a particular product or group of products in order to encourage sales, preferably comprising merchandizing product to shoppers in a shopping area of a store. A promotion comprises promotion attribute(s) that characterize the promotion.

“Promotion time period” is a finite period of time or duration that a promotion is made available to shoppers at the store (e.g., 1 day, 3 days, 1 week, and the like).

“Store” is a retail store, such as WAL-MART or TESCO. The term “store” may include many retail stores (associated with a chain, specific retailer, region, and the like), or a single, individual retail store.

“Target promotion” is a promotion that is planned, or being planned, comprising one or more target products. The target promotion may even be a hypothetical event with hypothetical data. The target product may comprise a pre-existing product (one currently being sold or one that has been sold in the market), or a prototypical product/hypothetical product, or the like.

“Historical promotion” is a promotion that took place in the past, relative to the target promotion, comprising one or more historical products. A historical promotion and a target promotion may have one or more promotion attributes that may be in common or substantially in common with each other.

“Volume” is used broadly to mean the number of products sold over a given period of time in a given store. Volume may be further defined as base volume, absolute volume, or promotion volume. “Base volume” is the number of products sold that is not generally influenced by a promotion. “Promotion volume” is the number of promotion products sold during and attributable to the promotion in question. “Absolute volume” is the total number product(s) sold irrespective of promotions that may or may not be occurring.

### Forecasting Volume:

One aspect of the invention provides for a method of forecasting target volume of a target product of a target promotion in a store comprising the steps: (a) defining target promotion attributes of the target promotion, wherein the target promotion attributes comprise the target product, a target product promotion price, a target promotion time period, and combinations thereof; (b) assessing purchase data of a store, wherein the purchase data comprises data about a historical promotion, wherein the historical promotion comprises historical promotion attributes; wherein the historical promotion attributes comprise: a historical product, a historical product promotion price, a historical promotion time period, and combinations thereof; (c) identifying one or more historical promotion(s) (e.g., 2, 3, 4, 5, 6, 7, 8, 9, 10 or more historical promotions) from the assessed purchase data that matches the target promotion based on the respective target promotion attributes and historical promotion attributes; (d) identifying a single highest selling historical promotion from the one or more identified historical promotion(s); (e) determining a historical volume of the historical product of the identified single highest selling historical promotion; and (f) forecasting the target volume of the target product of the target promotion based upon the determined volume of the historical product.

The term “highest selling” means the most number of product(s) sold on an equivalent time basis (i.e., taking in to account any differences in the duration of the target promotion and the historical promotion).

The term “based upon” means using the determined volume of the historical product of the identified single highest selling historical promotion and optionally modifying the volume number taking into account any variables that may influence the accuracy of the forecasting.

Without wishing to be bound by theory, the impact of a promotion is not fully realized at a store because many promotions suffer from “out-of-stock” product inventory at the individual store level and the lost sales associated with being out of stock. A surprising discovery is that if a store forecasts the product volume of a target promotion based on the store's highest selling historical promotion and such product inventory is timely delivered to the store (to meet the increase in demand spurred by the target promotion), the store will typically meet that product volume forecasted. In other words, and again without wishing to be bound by theory, the impact of a promotion is often not fully realized since often the target product inventory is not available to meet demand. However, given the multitude of product promotions that may be happening concurrently in a given store, with the ever increasing competitive market place, inventory control and management for stores are important in efficiency and remaining competitive, and thus “over ordering” any specific product is not an attractive option. However, the present invention provides a simple means of accurately predicting the impact of a target promotion and places the resources behind a promotion (e.g., inventory management) to fully maximize the promotion impact—on the granular level (e.g., store-by-store basis) that is needed.

In one embodiment, the method of forecasting target product volume of a target promotion is conducted on a single, individual store basis (or “store-by-store basis”). Without wishing to be bound by theory, the simple manner of forecasting volume, as presented by the present invention, allows the forecaster to go into a deeper level of granularity (i.e., on an individual store basis) without the transaction costs and/or complexities associated with more complicated modeling approaches.

Given this simplicity, there is no need, in one aspect of the invention, to take into account “base volume.” That is, in one embodiment the method is one which is free or substantially free of calculating the base volume of a target product. In another embodiment, the method provides determining the “absolute volume” (e.g., base volume+promotion volume) of the historical product of the identified single highest selling historical promotion to which the forecasted volume of the target product is based upon. An example of ways to calculate base volume include those described in US 2005/0273380 A1, paragraphs 32-42.

The simplicity of the present invention also lends itself to adoption by speaking a “common language” between a retailer and manufacturer, and the use of relatively inexpensive and widely available computer programs (such as EXCEL) to execute the methods described herein.

### Identifying Historical Promotion(s).

One aspect of the invention provides for identifying one or more historical promotion(s) from the assessed purchase data that matches the target promotion based on the respective target promotion attributes and historical promotion attributes. The term “matches” means comparing, analogizing, or the like, the various attributes between the historical promotion and the target promotion. For purposes of clarification, “matches” need not mean identifying those promotion attributes that exactly align with each other, but rather identifying those attributes that are likely most analogous and/or perhaps have the greatest influence to the accuracy/precision of the forecasting herein. There are various promotion attributes to consider including product, product price, promotion time period, and the like, and combinations thereof

Promotion attributes may include: (i) type of promotion; (ii) the product or products featured in the promotion; (iii) price of the product or products; (iv) in-store promotion location (i.e., where in the store was the promotion executed, preferably comprising the products in a promotion display (e.g., end cap, main aisle, promotional area)); (v) time relevancy of the promotion (i.e., how recently the historical promotion was executed relative to the target promotion (e.g., 1 month earlier, 6 months earlier, 1 year earlier, and the like); (vi) store compliance (i.e., asking whether the store complied with all the aspects of the program (e.g., ran circulars, posted advertising, and the like)); (vii) calendar timing (e.g., promoting coffee in the winter verses the spring; or 1-day promotion on the weekend verses the weekday) (viii) and the like; and (ix) combinations thereof.

The term “type of promotions” means a category of promotions. Examples of types of promotions include: a temporary price reduction, a distributed coupon campaign, an in-store coupon campaign, a loyalty card promotion, a rebate, an advertised price reduction, a sweepstakes, a free gift offered with purchase of the product, an attached coupon for reduced cost for another service or product, and the like, and combinations thereof. Types of promotions (or so-called “marketing components”) may include those described in US 2005/0278211 A1, paragraphs 11-14.

In one embodiment of the invention, the use of statistical analysis may help match those promotion attributes (between the historical promotion and the target promotion) that provide the greatest influence in forecasting (e.g., in the accuracy/precision of the forecasting), and optionally weigh those attributes/variables accordingly. For example, “regression analysis” is a well known statistical analysis technique by which the extent of each of a plurality of variables correlates with each of a plurality of outcomes is represented by a coefficient indicative of the strength of the correlation.

Examples of statistics and statistical techniques include: regression (e.g., Choosing and Using Statistics, Calvin Dytham, Blackwell Science, 2003, page 181 et seq.); pooled regression (e.g., Introducing Multilevel Modeling, Ita G. G. Kreft & Jan de Leeuw, Sage Publications Ltd, 2004, page 26 et seq.); ordinary least squares (OLS) regression (e.g., Applied Multiple Regression/Correlation Analysis for the Behavioral Sciences, Jacob Cohen et al., Lawrence Erlbaum Associates, 2003, page 124 et seq., ); mixed modeling (e.g., Mixed Models: Theory and Application, Eugene Demidenko, John Wiley & Sons, Inc., 2004); multivariate regression modeling (Bayesian Data Analysis, Andrew Gelman & Hal S. Stem, CRC Press LLC, 2004, page 481 et seq.); and the like. Analysis programs executable on a computer to mathematically model and normalize data input into the model are also known in the art. Examples may include STATGRAPHICS from StatPoint, Inc., Herndon, Va. 20171; SAS® from SAS Institute, Inc., (Step-By-Step Basics Statistics Using SAS, Larry Hatcher, SAS Institute, Inc, 2003) (see example of output as provided as FIGS. 1A, 1B, and 1C); SPSS® from SPSS Inc., (Discovering Statistics Using SPSS, Andy Field, SAGE Publications Ltd., 2005); MATLAB® from MathWorks, Inc. (MATLAWPrimer (7th edition), Timothy A Davis & Kermit Sigmon, CRC Press LLC, 2005; or Graphics and Guis with MATLAB, Patrick Marchand & O. Thomas Holland, 3^{rd} edition, CRC Press LLC, 2003); and the like.

### Optimizing the Mix of Products

One aspect of the invention provides for a method of optimizing a mix of products, on an individual store basis, for a target promotion promoting products across a plurality of stores, wherein the optimized mix of products maximizes the overall number of products that are sold during the target promotion, wherein the method comprises the steps: (a) assessing historical purchase data on an individual store basis to identify the single highest selling historical promotion, wherein the historical promotion and the target promotion comprise substantially the same products on a Stock Keeping Unit (SKU) basis and substantially the same price for each SKU; (b) determining a historical volume of each product of the identified single highest selling historical promotion; (c) forecasting a target volume of each product of the target promotion based upon the determined volume for the respective product of the identified single highest selling historical promotion; (d) optimizing the mix of products for each store for the target promotion based on the forecasted volume of each product to maximize the number of stores that can sell through the products of the target promotion; (e) shipping the optimized mix of products for each store. Without wishing to be bound by theory, by optimizing the mix of products (i.e., the correct ratio/percentage and quantities of the products) offered during the promotion will strike the right balance of not being out-of-stock but also mitigating the effects of the accumulation of products that are not selling as fast (e.g., maintaining inventory, taking valuable shelf space with less shopper-desirable products, and the like).

### Systems

Yet another aspect of the invention provides for systems and computer program products. The systems of the present invention include at least one computer-readable medium used for storing computer instructions, data, program products, and the like. A general example of a computer is described in US 2006/0010027 A1, paragraph 78. Examples of computer readable media are compact discs, hard disks, floppy disks, tape, magneto-optical disks, PROMs (EPROM, EEPROM, Flash EPROM, etc.), DRAM, SRAM, SDRAM, etc. Stored on any one or on a combination of computer readable media, the present invention includes software for controlling both the hardware of the computer and for enabling a user to interact with the computer to conduct the methods herein described. Such software may include, but is not limited to, device drivers, operating systems and user applications.

Examples of a retailer include WAL-MART, TARGET, KROGERS, CVS, WALGREENS, COSTCO, SAMS CLUB, and the like.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of forecasting target volume of a target product of a target promotion in a store comprising the steps:
(a) defining target promotion attributes of the target promotion, wherein the target promotion attributes comprise the target product, a target product promotion price, a target promotion time period, or combinations thereof;
(b) assessing purchase data of a store,
wherein the purchase data comprises data about a historical promotion,
wherein the historical promotion comprises historical promotion attributes;
wherein the historical promotion attributes comprise: a historical product, a historical product
promotion price, a historical promotion time period, and combinations thereof;
(c) identifying one or more historical promotion(s) from the assessed purchase data that matches the target promotion based on the respective target promotion attributes and historical promotion attributes;
(d) identifying a single highest selling historical promotion from the one or more identified historical promotion(s);
(e) determining a historical volume of the historical product of the identified single highest selling historical promotion; and
(f) forecasting the target volume of the target product of the target promotion based upon the determined volume of the historical product.

2. The method of claim 1, wherein the step of assessing the purchase data of a store comprises assessing on a store-by-store basis.

3. The method of claim 1, wherein promotion attributes comprise: the target product, the target product promotion price, and the target promotion time period.

4. The method of claim 3, wherein the step of assessing the purchase data of a store comprises assessing on a store-by-store basis; and wherein identifying one or more historical promotion(s) from the assessed purchase data comprises identifying at least two historical promotions.

5. The method of claim 1, wherein the promotion attributes further comprise at least one of the following: (i) type of promotion; (ii) in-store promotion location; (iii) time relevancy of the promotion; (iv) store compliance; (v) calendar timing; and (vi) combinations thereof.

6. The method of claim 3, wherein the promotion attributes further comprise at least one of the following: (i) type of promotion; (ii) in-store promotion location; (iii) time relevancy of the promotion; (iv) store compliance; (v) calendar timing; and (vi) combinations thereof.

7. The method of claim 6, wherein the step of assessing the purchase data comprises assessing on a store-by-store basis.

8. The method of claim 2, wherein the method is free of assessing base volume of the historical product of the historical product promotion.

9. The method of claim 8, wherein determining the volume of the historical product comprises determining an absolute volume of the historical product of the historical product promotion.

10. A method of forecasting volume of a target product of a target promotion in a store comprising the steps:
(a) defining target promotion attributes of the target promotion;
(b) assessing purchase data of a store,
wherein the purchase data comprises data about a historical promotion,
wherein the historical promotion comprises historical promotion attributes;
(c) identifying one or more historical promotion(s) from the assessed purchase data that matches the target promotion based on the respective target promotion attributes and historical promotion attributes,
wherein the historical promotion attributes or target promotion attributes are matched by statistical analysis by their degree of influence on forecasting the volume of the target product;
(d) identifying a single highest selling historical promotion from the one or more identified historical promotions);
(e) determining a volume of the historical product of the identified single highest selling historical promotion; and
(f) forecasting the volume of the target product of the target promotion based upon the determined volume of the historical product.

11. The method of claim 10,
wherein the step of assessing the purchase data of a store comprises assessing on a store-by-store basis; and
wherein promotional attributes are chosen from (i) type of promotion; (ii) product(s); (iii) price of the product(s); (iv) in-store promotion location (v) time relevancy of the promotion; (vi) store compliance; (vii) calendar timing; (viii) promotion time period; and (ix) combinations thereof

12. The method of claim 10, wherein the method is free of assessing base volume of the historical product of the historical product promotion.

13. The method of claim 12, wherein determining the volume of the historical product comprises determining an absolute volume of the historical product of the historical product promotion.

14. A method of optimizing a mix of products, on an individual store basis for a target promotion promoting products across a plurality of stores, wherein the optimized mix of products maximizes the overall number of products that are sold during the target promotion, wherein the method comprises the steps:
(a) assessing historical purchase data on an individual store basis to identify the single highest selling historical promotion, wherein the historical promotion and the target promotion comprise substantially the same products on a Stock Keeping Unit (SKU) basis and substantially the same price for each SKU;
(b) determining a historical volume of each product of the identified single highest selling historical promotion;
(c) forecasting a target volume of each product of the target promotion based upon the determined volume for the respective product of the identified single highest selling historical promotion;
(d) optimizing the mix of products for each store for the target promotion based on the forecasted volume of each product to maximize the number of stores that can sell through the products of the target promotion;
(e) shipping the optimized mix of products for each store.

15. The method of claim 14, wherein the step of shipping the optimized mix of product for each store comprises shipping the optimized mix of product via pallet(s), wherein each pallet comprises the optimized mix of products.

16. The method of claim 14, wherein the step of determining the historical volume of each product of the identified single highest selling historical promotion comprises determining an absolute volume of the historical product of the historical product promotion.

17. The method of claim 16, wherein the method is free of assessing base volume of the products of the historical product promotion.

18. The method of claim 14, wherein the target promotion and the historical promotion each have at least three products in common having the same SKU.

19. The method of claim 14, wherein the target promotion comprises a new product, wherein the new product comprises a new SKU.

20. The method of claim 15,
wherein the step of determining the historical volume of each product of the identified single highest selling historical promotion comprises determining an absolute volume of the historical product of the historical product promotion;
wherein the method is free of assessing base volume of the products of the historical product promotion; and
wherein the target promotion and the historical promotion each have at least three products in common having the same SKU.
